(19) United States
(12) Patent Application Publication
(10) Pub. No.: US 2025/0044088 A1
(43) Pub. Date: Feb. 6, 2025

(54) Laser System for Generating a Laser Line

(71) Applicant: Hilti Aktiengesellschaft, Schaan (LI)

(72) Inventor: Lieu-Kim DANG, Gams (CH)

(21) Appl. No.: 18/716,427

(22) PCT Filed: Dec. 19, 2022
(86) PCT No.: PCT/EP2022/086637

§ 371 Date: Jun. 4, 2024

(30) Foreign Application Priority Data
Dec. 23, 2021 (EP) 21217423.9

(51) Int. Cl. G01C 15/00

(52) U.S. Cl. CPC G01C 15/004

(57) ABSTRACT

A laser system for generating a laser line includes a laser beam source which generates a laser beam, a beam-shaping optical unit which is configured as a focusing optical unit and reshapes the laser beam into a focused laser beam, and a deflection optical unit which deflects an incident laser beam into a propagation plane perpendicularly to a beam axis of the incident laser beam. An adjustable diaphragm device is disposed between the laser beam source and the deflection optical unit.

### BACKGROUND AND SUMMARY OF THE INVENTION

The present invention relates to a laser system for generating a laser line.

In order to carry out leveling or marking work indoors and outdoors, laser systems which generate a laser line on a projection surface are known. In these laser systems, a distinction is made between rotary lasers, which generate the laser line by rotating a deflection optical unit around an axis of rotation, and line lasers, which generate the laser line using a beam-shaping optical unit, for example a cylindrical lens, a pentaprism or a conical mirror. In order that the known laser systems can be used without protective measures in the form of protective goggles and reflectors, the laser power must be limited in order to prevent damage to the human eye. For laser systems in laser class 2 or 2M, the maximum permissible laser power is 1 mW.

Known laser systems can usually be used in at least two different distance ranges. The width of the laser line that the laser systems generate on a projection surface depends, among other things, on the distance of the laser system from the projection surface. Starting from the laser system, the width of the laser line decreases and reaches a minimum value in the beam waist. With greater distances between the laser system and the projection surface, the width of the laser line increases again behind the beam waist.

In order to generate a narrow laser line on a projection surface, laser systems with an adjustable focusing optical unit are known. The adjustable focusing optical unit makes it possible to shift the position of the beam waist of the laser beam.

The object of the present invention is to develop a laser system with which a narrow laser line can be generated in at least two distance ranges of the laser system from a projection surface. In addition, the laser line should be clearly visible on the projection surface for the at least two distance ranges.

According to the invention, the laser system is characterized in that an adjustable diaphragm device is arranged between the laser beam source and the deflection optical unit. The adjustable diaphragm device can shape the laser beam that the laser beam source generates and reduce the beam diameter. The beam diameter is in this case reduced by way of the aperture diameter of the diaphragm aperture.

The diaphragm device is preferably adjustable between a first position and a second position. A diaphragm device which is adjustable between a first position and a second position can produce a first beam diameter in the first position and a second beam diameter smaller than the first beam diameter in the second position.

The laser system according to the invention is designed such that the first beam diameter is provided for a first distance range and the second beam diameter is provided for a second distance range, the first distance range comprising greater distances than the second distance range. Since the visibility of a laser line decreases with greater distances, it is advantageous that the larger first beam diameter is provided for greater distances, since the full laser power can be used at greater distances. The focusing optical unit of the laser system is selected such that the beam waist of the laser beam lies in the first distance range and a narrow, clearly visible laser line is generated on the projection surface. At smaller distances, the laser power is reduced by the diaphragm device; limiting the beam diameter has a positive effect on the width of the laser line (narrow laser line) and is not critical with regard to the visibility of the laser line on the projection surface.

In a preferred embodiment, the diaphragm device has a first aperture diameter in the first position and a second aperture diameter in the second position, the first aperture diameter and the second aperture diameter being different.

In an alternative preferred embodiment, the diaphragm device is arranged outside the beam path of the laser beam in the first position and in the beam path of the laser beam in the second position. If the diaphragm device is arranged in the first position outside the beam path of the laser beam, the laser beam is not limited. If the diaphragm device is arranged in the second position in the beam path of the laser beam, the laser beam is limited by the diaphragm device. A narrow laser line, the width of which is smaller than without the limitation of the laser beam, is generated on a projection surface.

In a preferred embodiment, the diaphragm device is designed as an iris diaphragm which is adjustable between a minimum diaphragm aperture and a maximum diaphragm aperture. The use of an iris diaphragm as the diaphragm device has the advantage that the diaphragm aperture is steplessly adjustable. The user can use the iris diaphragm at different distances between the laser system and a projection surface to generate a narrow laser line.

In an alternative preferred embodiment, the diaphragm device has a circular aperture and a first circular ring, the first circular ring being arranged concentrically to the circular aperture and being switchable between a first state and a second state. The first circular ring is preferably designed to be transmissive to the wavelength of the laser beam source in the first state with a transmittance T greater than 90% and non-transmissive in the second state with a transmittance T less than 10%.

A first circular ring which is switchable between a transmissive first state and a non-transmissive second state allows the shaping of a first laser beam with a first beam diameter and a second laser beam with a second beam diameter smaller than the first beam diameter. The first beam diameter is in this case designed for a first distance range and the second beam diameter is designed for a second distance range, the first distance range comprising greater distances than the second distance range.

The diaphragm device preferably has a second circular ring, the second circular ring being arranged concentrically to the first circular ring and being switchable between a first state and a second state. Preferably, the second circular ring is transmissive to the wavelength of the laser beam source in the first state with a transmittance T greater than 90% and non-transmissive in the second state with a transmittance T less than 10%.

A second circular ring, which is arranged concentrically to the first circular ring and is switchable between a transmissive first state and a non-transmissive second state, allows the shaping of a third laser beam with a third beam diameter which is smaller than the second beam diameter. In this case, the third beam diameter is designed for a third distance range, the third distance range comprising smaller distances than the second distance range.

Exemplary embodiments of the invention are described hereinafter with reference to the drawings. It is not necessarily intended for the drawings to illustrate the exemplary embodiments to scale; rather, the drawings are produced in a schematic and/or slightly distorted form where this is useful for the purposes of explanation. It should be taken into account here that various modifications and variations relating to the form and detail of an embodiment may be undertaken without departing from the general concept of the invention. The general concept of the invention is not limited to the exact form or the detail of the preferred embodiment shown and described hereinafter or limited to subject matter that would be limited compared with the subject matter claimed in the claims. For given dimensioning ranges, values within the stated limits should also be disclosed as limit values and can be used and claimed as desired. For the sake of simplicity, the same reference numerals are used below for identical or similar parts or parts with identical or similar functions.

### BRIEF DESCRIPTION OF THE DRAWINGS

FIG. 1 shows a laser system according to the invention, which has a laser beam source, a focusing optical unit, a deflection optical unit and an adjustable diaphragm device;

FIGS. 2A, B show the laser system of FIG. 1 in a first position (FIG. 2A) and a second position (FIG. 2B) of the diaphragm device;

FIGS. 3A, B show a further laser system according to the invention with an adjustable diaphragm device in a first position (FIG. 3A) and a second position (FIG. 3B) of the diaphragm device;

FIGS. 4A, B show a diaphragm device, designed as an iris diaphragm, which is steplessly adjustable between a minimum diaphragm aperture (FIG. 4A) and a maximum diaphragm aperture (FIG. 4B);

FIG. 5 shows a further diaphragm device designed as a diaphragm wheel, which is adjustable between a first position, a second position and a third position;

FIG. 6 shows a further diaphragm device, which is adjustable between a first position, a second position and a third position; and

FIGS. 7A-C show the diaphragm device of FIG. 6 in the first position (FIG. 7A), the second position (FIG. 7B) and the third position (FIG. 7C).

### DETAILED DESCRIPTION OF THE DRAWINGS

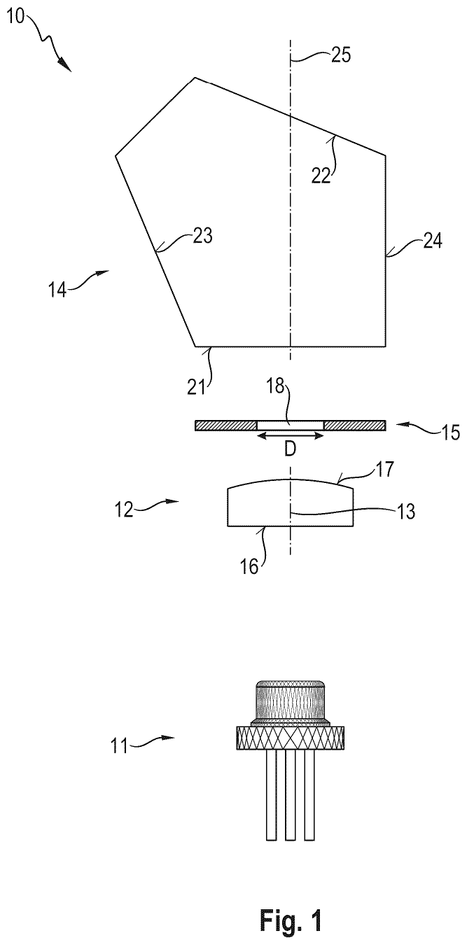

FIG. 1 shows a laser system 10 according to the invention, which is designed as a rotary laser, and a laser line is generated on a projection surface. The laser system 10 comprises a laser beam source 11, a beam-shaping optical unit 12, designed as a focusing optical unit, with an optical axis 13, a deflection optical unit, designed as a pentaprism 14, and a diaphragm device 15. The components of the laser system 10 are arranged in the order laser beam source 11, focusing optical unit 12, diaphragm device 15 and deflection optical unit 14.

The laser beam source 11 may be designed as a semiconductor laser with a wavelength in the visible spectrum, for example as a red semiconductor laser with a wavelength of 635 nm or as a green semiconductor laser with a wavelength of between 510 and 555 nm. The properties of the further optical components 12, 14, 15 of the laser system 10 are adapted to the wavelength of the laser beam source 11.

In the exemplary embodiment, the focusing optical unit 12 has a planar entry surface 16 and a curved exit surface 17. Alternatively, the entry surface 16 may be designed as a curved surface and the exit surface 17 as a planar surface, or the entry and exit surfaces 16, 17 are designed as curved surfaces. The optical axis 13 of the focusing optical unit 12 is defined as a straight line which runs through the center of curvature of the curved surface and is perpendicular to the planar surface or, in the case of two curved surfaces, runs through the centers of curvature of the curved surfaces.

The diaphragm device 15, which is arranged between the focusing optical unit 12 and the deflection optical unit 14, is adjustable between a first position and a second position. The diaphragm device 15 has a diaphragm aperture 18 with an aperture diameter D. In the first position the diaphragm aperture 18 has a first aperture diameter and in the second position a second aperture diameter, which is different from the first aperture diameter.

The deflection optical unit 14 designed as a pentaprism has an entry surface 21, a first reflection surface 22, a second reflection surface 23 and an exit surface 24. The entry surface 21 and the exit surface 24 are designed as transmission surfaces for the wavelength of the laser beam source 11 and a laser beam incident on the entry or exit surface 21, 24 is predominantly transmitted. The first reflection surface 22 and the second reflection surface 23 are designed as reflection surfaces for the wavelength of the laser beam source 11 and an incident laser beam is predominantly reflected.

The laser system 10 is designed as a rotary laser. The deflection optical unit 14 designed as a pentaprism is moved about an axis of rotation 25 by means of a motor unit. The axis of rotation 25 in this case runs parallel to the beam axis of a laser beam entering the pentaprism 14.

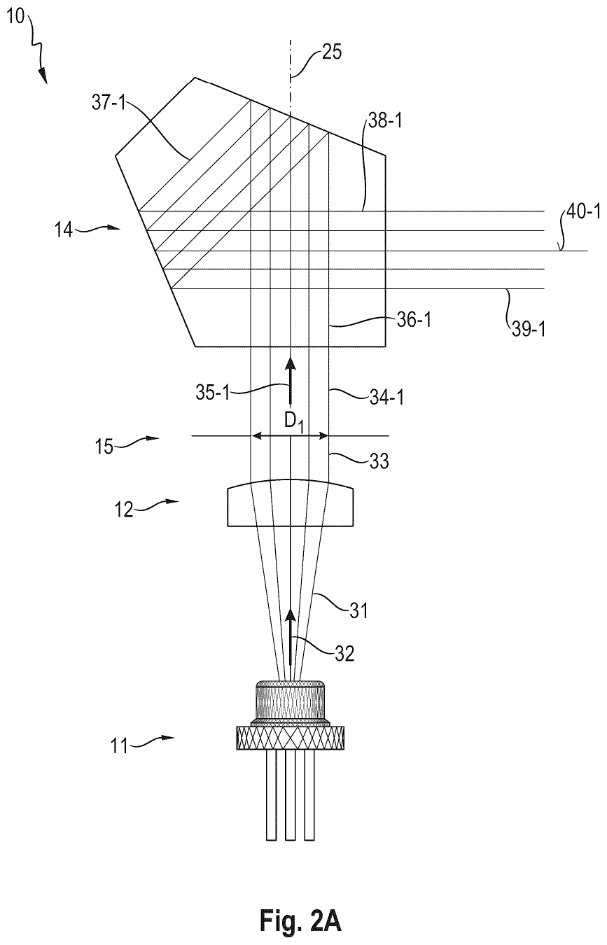

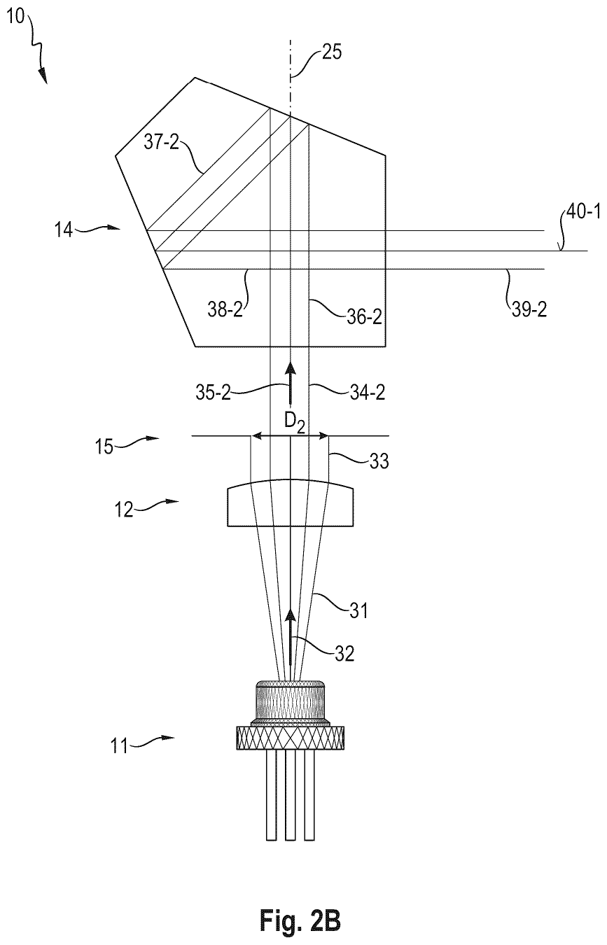

FIGS. 2A, B show the laser system 10 according to the invention of FIG. 1, which generates a laser line on a projection surface. The laser system 10 comprises the laser beam source 11, the focusing optical unit 12, the diaphragm device 15 and the pentaprism 14. The laser system 10 is adjustable using the diaphragm device 15 between a first position (FIG. 2A) and a second position (FIG. 2B).

The laser beam source 11 generates a divergent laser beam 31, which is emitted along a propagation direction 32. The axis of symmetry of the beam distribution is defined as the optical axis of the laser beam. The laser beam 31 preferably has a beam distribution in the form of a Gaussian distribution, a Lorentz distribution or a Bessel distribution. These beam distributions do not have an abrupt jump in intensity and help to generate a sharply delimited laser line on a projection surface.

The divergent laser beam 31 is incident on the focusing optical unit 12, which generates a focused laser beam 33. The focused laser beam 33 is incident on the diaphragm device 15, which can shape the laser beam. In the case of the first position, shown in FIG. 2A, the diaphragm aperture 18 has a first aperture diameter D₁ and in the case of the second position, shown in FIG. 2B, the diaphragm aperture 18 has a second aperture diameter D₂, which is smaller than the first aperture diameter D₁.

The diaphragm device 15 generates in the first position a first shaped laser beam 34-1 with a first beam axis 35-1 (FIG. 2A) and in the second position a second shaped laser beam 34-2 with a second beam axis 35-2 (FIG. 2B). The first aperture diameter D₁ is selected such that the first shaped laser beam 34-1 passes the diaphragm aperture 18 almost unchanged, whereas the second aperture diameter D₂ is selected such that the second shaped laser beam 34-2 is limited by the diaphragm aperture 18 in the peripheral area. As an alternative to the first position, shown in FIG. 2A, the diaphragm device 15 can be adjusted to a position outside the beam path of the laser beam.

The first or second shaped laser beam 34-1, 34-2 is incident on the entry surface 21 and enters the pentaprism 14 as the first or second transmitted laser beam 36-1, 36-2 through the entry surface 21. In the pentaprism 14 there is a first reflection at the first reflection surface 22 and a second reflection at the second reflection surface 23. The laser beam reflected at the first reflecting surface 22 is referred to as the first or second once-reflected laser beam 37-1, 37-2 and the laser beam reflected at the second reflecting surface 23 is referred to as the first or second twice-reflected laser beam 38-1, 38-2. The first or second twice-reflected laser beam 38-1, 38-2 is incident on the exit surface 24, leaves the pentaprism 14 as the first or second deflected laser beam 39-1, 39-2 and generates a laser line on a projection surface. The first reflection surface 22 and the second reflection surface 23 are aligned with one another in such a way that the first or second deflected laser beam 39-1, 39-2 propagates in a propagation plane 40-1, 40-2, which is arranged perpendicularly to the first or second beam axis 35-1, 35-2 of the first or second shaped laser beam 34-1, 34-2.

By the diaphragm device 15, which is adjustable between the first position (FIG. 2A) and the second position (FIG. 2B), the width of the laser line can be set in two distance ranges. In addition to the first and second aperture diameters D₁, D₂, the diaphragm device 15 can be adjusted steplessly or in discrete steps between the first aperture diameter D₁ and the second aperture diameter D₂.

The first deflected laser beam 39-1 with a first beam diameter is provided for a first distance range and the second deflected laser beam 39-2 with a second beam diameter is provided for a second distance range, the first distance range comprising greater distances than the second distance range. Since the visibility of a laser line decreases with greater distances, it is advantageous that the larger first beam diameter is provided for greater distances, since the full laser power can be used at greater distances.

The focusing optical unit 12 of the laser system 10 is selected such that the beam waist of the laser beam lies in the first distance range and a narrow, clearly visible laser line is generated on the projection surface. At smaller distances, the laser power is reduced by the diaphragm device 15; limiting the beam diameter has a positive effect on the width of the laser line (narrow laser line) and is not critical with regard to the visibility of the laser line on the projection surface.

As an alternative to the deflection optical unit 14 designed as a pentaprism, a deflection optical unit which has a first mirror and a second mirror may be used. The first mirror in this case replaces the first reflection surface 22 and the second mirror replaces the second reflection surface 23 of the pentaprism 14. The first and second mirrors are arranged analogously to the first and second reflection surfaces 22, 23 in such a way that the deflected laser beam is arranged perpendicularly to the beam axis of the incident laser beam.

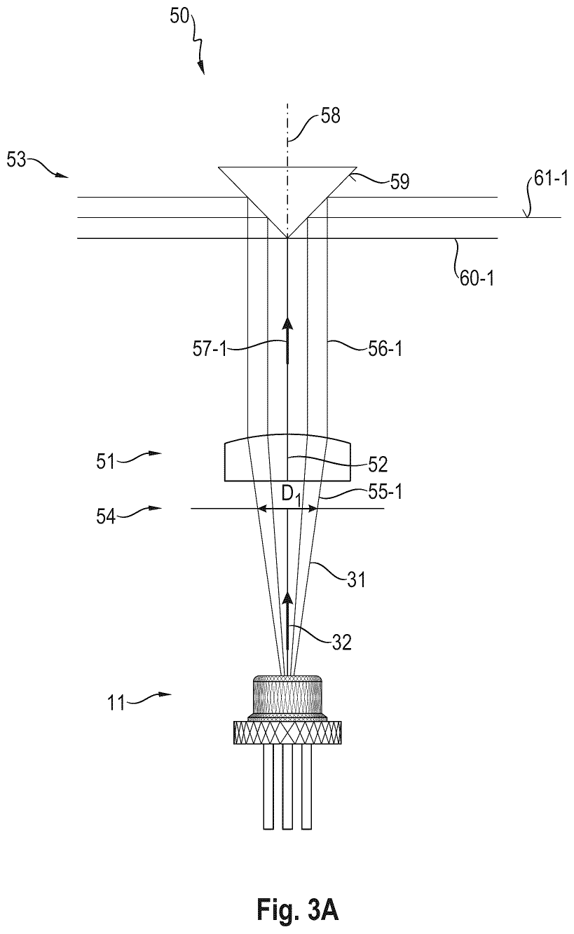

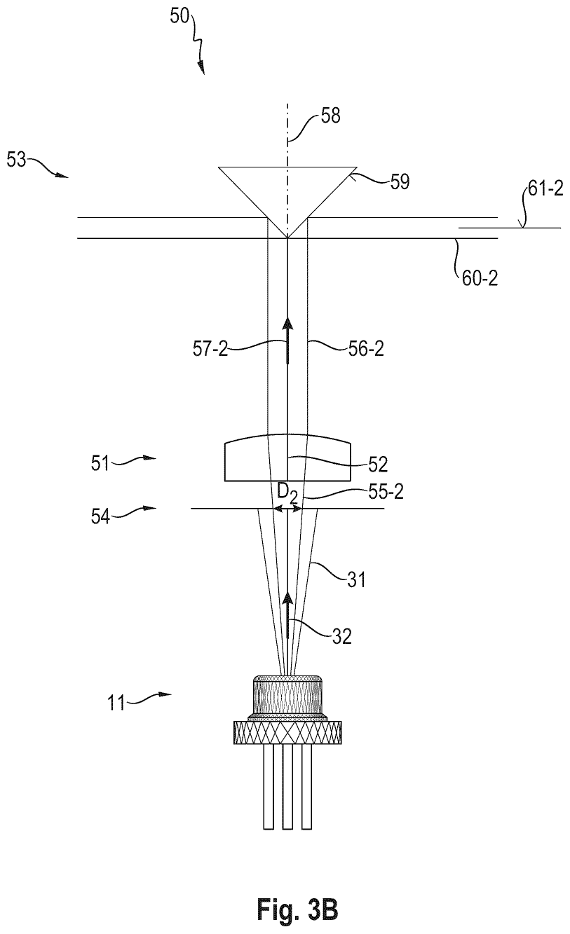

FIGS. 3A, B show a further embodiment of a laser system 50 according to the invention, which is designed as a line laser and generates a laser line on a projection surface.

The laser system 50 comprises the laser beam source 11, a beam-shaping optical unit designed as a focusing optical unit 51 with an optical axis 52, a deflection optical unit designed as a conical mirror 53 and a diaphragm device 54. The components of the laser system 50 are arranged in the order laser beam source 11, diaphragm device 54, focusing optical unit 51 and deflection optical unit 53. The laser system 50 is adjustable using the diaphragm device 54 between a first position (FIG. 3A) and a second position (FIG. 3B).

The laser beam source 11 generates the divergent laser beam 31, which is emitted along the direction of propagation 32 and is incident on the diaphragm device 54, which can shape the divergent laser beam 31. In the case of the first position, shown in FIG. 3A, the diaphragm device 54 has a first aperture diameter D₁ and in the case of the second position, shown in FIG. 3B, the diaphragm device 54 has a second aperture diameter D₂, which is smaller than the first aperture diameter D₁.

The diaphragm device 54 generates in the first position a first shaped laser beam 55-1 (FIG. 3A) and in the second position a second shaped laser beam 55-2 (FIG. 3B). The first and second shaped laser beams 55-1, 55-2 are incident on the focusing optical unit 51, which generates a first and a second focused laser beam 56-1, 56-2 with a first and a second beam axis 57-1, 57-2. The first or second focused laser beam 56-1, 56-2 is incident on the deflection optical unit 53 designed as a conical mirror.

The conical mirror 53 is designed as a portion of a right cone with a cone axis 58 and has a lateral surface 59, which is designed as a reflection surface for the wavelength of the laser beam source 11. The first or second focused laser beam 56-1, 56-2 incident on the lateral surface 59 is predominantly reflected at the lateral surface 59 and reshaped into a first or second deflected laser beam 60-1, 60-2. The first or second deflected laser beam 60-1, 60-2 propagates in a propagation plane 61-1, 61-2, which is arranged perpendicularly to the first or second beam axis 57-1, 57-2 of the focused laser beam 56-1, 56-2.

By the diaphragm device 54, which is adjustable between the first position (FIG. 3A) and the second position (FIG. 3B), the width of the laser line can be set in two distance ranges. In addition to the first and second aperture diameters D₁, D₂, the diaphragm device 54 can be adjusted steplessly or in discrete steps between the first aperture diameter D₁ and the second aperture diameter D₂.

The first deflected laser beam 60-1 with a first beam diameter is provided for a first distance range and the second deflected laser beam 60-2 with a second beam diameter smaller than the first beam diameter is provided for a second distance range, the first distance range comprising greater distances than the second distance range. Since the visibility of a laser line decreases with greater distances, it is advantageous that the larger first beam diameter is provided for greater distances, since the full laser power can be used at greater distances.

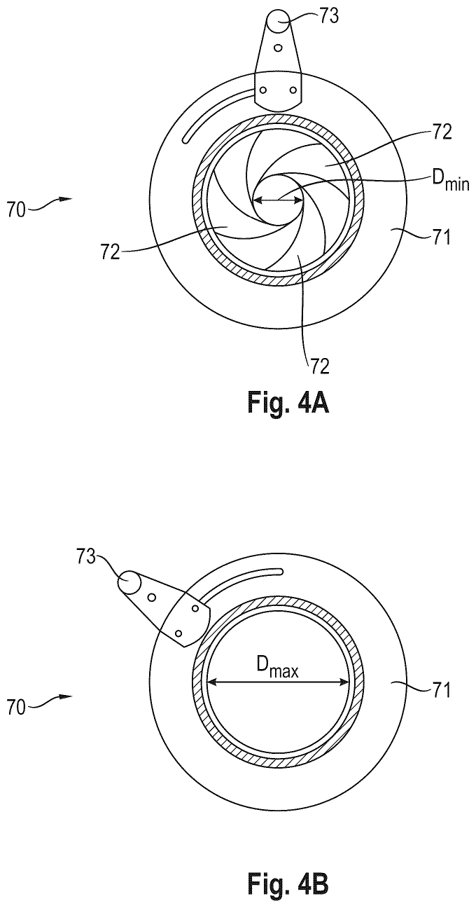

FIGS. 4A, B show a diaphragm device 70, designed as an iris diaphragm, which is adjustable steplessly between a minimum diaphragm aperture Dₘᵢₙ (FIG. 4A) and a maximum diaphragm aperture Dₘₐₓ (FIG. 4B). The iris diaphragm 70 can replace the diaphragm device 15 in the laser system 10 and the diaphragm device 54 in the laser system 50.

The iris diaphragm 70 consists of a ring 71 and multiple lamellae 72, which by way of a lever 73 can together be turned inward or outward. Using the lever 73, the iris diaphragm 70 can be adjusted steplessly between the minimum aperture Dₘᵢₙ and the maximum aperture Dₘₐₓ. Each lamella 72 is mounted on a separate axis and all of the lamellae 72 are connected to the ring 71 by way of a further axis so that they move together. The more lamellae 72 are used, the better the diaphragm aperture can be approximated to the circular shape during the adjustment.

The use of the iris diaphragm 70 as the diaphragm device has the advantage that the diaphragm aperture can be adjusted steplessly. The user can adjust the width of the laser line that the laser system generates on a projection surface very precisely to his requirements and the distance range.

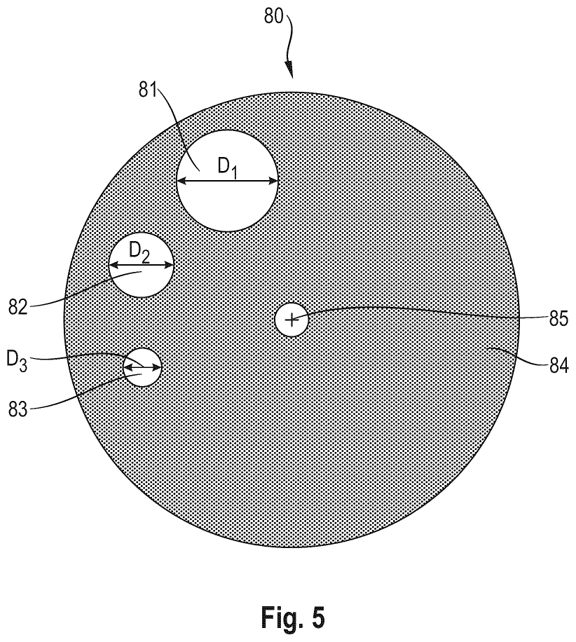

FIG. 5 shows a further diaphragm device 80, designed as a diaphragm wheel, which is adjustable between a first position, a second position and a third position. The diaphragm wheel 80 can replace the diaphragm device 15 in the laser system 10 and the diaphragm device 54 in the laser system 50.

The diaphragm wheel 80 has in the first position a first diaphragm aperture 81 with a first aperture diameter D₁, in the second position a second diaphragm aperture 82 with a second aperture diameter D₂ and in the third position a third diaphragm aperture 83 with a third aperture diameter D₃. The first diaphragm aperture 81, the second diaphragm aperture 82 and the third diaphragm aperture 83 are arranged in an optical unit support 84 and designed to be rotatable about an axis of rotation 85.

By rotating about the axis of rotation 85, the diaphragm wheel 80 can be adjusted between the first position, in which the first diaphragm aperture 81 is arranged in the beam path of the laser beam, the second position, in which the second diaphragm aperture 82 is arranged in the beam path of the laser beam, and the third position, in which the third diaphragm aperture 83 is arranged in the beam path of the laser beam.

In addition to the first, second and third diaphragm apertures 81, 82, 83, further diaphragm apertures may be integrated into the optical unit support 84. The diaphragm wheel 80 allows the diaphragm aperture to be adjusted in discrete steps.

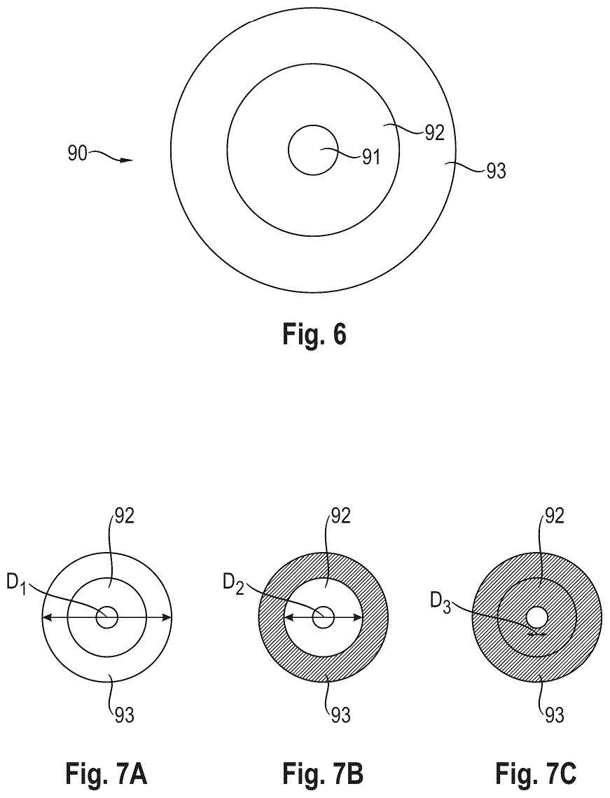

FIG. 6 shows another diaphragm device 90, which is adjustable between a first position, a second position and a third position. The diaphragm device 90 can replace the diaphragm device 15 in the laser system 10 and the diaphragm device 54 in the laser system 50.

The diaphragm device 90 has a circular aperture 91, a first circular ring 92 and a second circular ring 93. The first circular ring 92 and the second circular ring 93 are arranged concentrically to the circular aperture 91 and are switchable independently of one another between a first state (transmissive) and a second state (non-transmissive).

The first circular ring 92 is used as a polarization filter for an incident laser beam and is designed in such a way that its transmittance T can be adjusted. The first circular ring 92 is switchable between the first state, in which the transmittance T is greater than 90%, and the second state, in which the transmittance T is less than 10%, for the wavelength of the laser beam source 11.

The second circular ring 93 is used as a polarization filter for an incident laser beam and is designed such that its transmittance T is adjustable. The second circular ring 93 is switchable between the first state, in which the transmittance T is greater than 90%, and the second state, in which the transmittance T is less than 10%, for the wavelength of the laser beam source 11.

In the exemplary embodiment of FIG. 6, the circular aperture 91 is also used as a polarization filter for an incident laser beam and is designed such that its transmittance T is adjustable. The circular aperture 91 is switchable between the first state, in which the transmittance T is greater than 90%, and the second state, in which the transmittance T is less than 10%, for the wavelength of the laser beam source 11.

FIGS. 7A-C show the diaphragm device 90 of FIG. 6 in a first position (FIG. 7A), a second position (FIG. 7B) and a third position (FIG. 7C).

In the first position of the diaphragm device 90, shown in FIG. 7A, the circular aperture 91, the first circular ring 92 and the second circular ring 93 have been switched to the first state and are predominantly transmissive with a transmittance T greater than 90% for the wavelength of the laser beam source 11. The diaphragm device 90 has in the first position a first aperture diameter D₁, which corresponds to the outer ring diameter of the second circular ring 93.

In the second position of the diaphragm device 90, shown in FIG. 7B, the circular aperture 91 and the first circular ring 92 have been switched to the first state and the second circular ring 93 has been switched to the second state. The circular aperture 91 and the first circular ring 92 are predominantly transmissive with a transmittance T greater than 90% for the wavelength of the laser beam source 11 and the second circular ring 93 is predominantly non-transmissive with a transmittance T less than 10% for the wavelength of the laser beam source 11. The diaphragm device 90 has in the second position a second aperture diameter D₂, which corresponds to the outer ring diameter of the first circular ring 92.

In the third position of the diaphragm device 90, shown in FIG. 7C, the circular aperture 91 has been switched to the first state and the first circular ring 92 and second circular ring 93 are switched to the second state. The circular aperture 91 is predominantly transmissive with a transmittance T greater than 90% for the wavelength of the laser beam source 11 and the first circular ring 92 and the second circular ring 93 are predominantly non-transmissive with a transmittance T less than 10% for the wavelength of the laser beam source 11. The diaphragm device 90 has in the third position a third aperture diameter D₃, which corresponds to the circle diameter of the circular aperture 91.

The first and second circular rings 92, 93, which are switchable between a transmissive first state and a non-transmissive second state, allow the shaping of a first laser beam with a first beam diameter, a second laser beam with a second beam diameter and a third laser beam with a third beam diameter. The first beam diameter is in this case designed for a first distance range, the second beam diameter for a second distance range and the third beam diameter for a third distance range. The first distance range comprises greater distances than the second distance range and the first distance range comprises smaller distances as the first distance range.

1.-9. (canceled)

10. A laser system (10; 50) for generating a laser line, comprising:
a laser beam source (11) which generates a laser beam (31);
a beam-shaping optical unit (12; 51) which is configured as a focusing optical unit and reshapes the laser beam into a focused laser beam (34-1, 34-2; 56-1, 56-2);
a deflection optical unit (14; 53) which deflects an incident laser beam (34-1, 34-2; 56-1, 56-2) into a propagation plane (40-1, 40-2; 61-1, 61-2) perpendicularly to a beam axis (35-1, 35-2; 57-1, 57-2) of the incident laser beam (34-1, 34-2; 56-1, 56-2); and
an adjustable diaphragm device (15; 54; 70; 80; 90) disposed between the laser beam source (11) and the deflection optical unit (14; 53).

11. The laser system (10; 50) as claimed in claim 10, wherein the adjustable diaphragm device (15; 54; 70; 80; 90) is adjustable between a first position and a second position.

12. The laser system (10; 50) as claimed in claim 11, wherein the adjustable diaphragm device (15; 54) has a first aperture diameter (D₁) in the first position and a second aperture diameter (D₂) in the second position wherein the first aperture diameter (D₁) and the second aperture diameter (D₂) are different.

13. The laser system (10; 50) as claimed in claim 11, wherein the adjustable diaphragm device (15; 54) is disposed outside a beam path of the laser beam in the first position and in the beam path of the laser beam in the second position.

14. The laser system (10; 50) as claimed in claim 10, wherein the adjustable diaphragm device (70) is an iris diaphragm which is adjustable between a minimum diaphragm aperture (Dₘᵢₙ) and a maximum diaphragm aperture (Dₘₐₓ).

15. The laser system (10; 50) as claimed in claim 10, wherein the adjustable diaphragm device (90) has a circular aperture (91) and a first circular ring (92) and wherein the first circular ring (92) is disposed concentrically to the circular aperture (91) and is switchable between a first state and a second state.

16. The laser system (10; 50) as claimed in claim 15, wherein the first circular ring (92) is transmissive to a wavelength of the laser beam source (11) in the first state with a transmittance (T) greater than 90% and is non-transmissive in the second state with the transmittance (T) less than 10%.

17. The laser system (10; 50) as claimed in claim 15, wherein the adjustable diaphragm device (90) has a second circular ring (93) and wherein the second circular ring (93) is disposed concentrically to the first circular ring (92) and is switchable between a third state and a fourth state.

18. The laser system (10; 50) as claimed in claim 17, wherein the second circular ring (93) is transmissive to a wavelength of the laser beam source (11) in the third state with a transmittance (T) greater than 90% and is non-transmissive in the fourth state with the transmittance (T) less than 10%.
